(19) United States
(12) Patent Application Publication
(10) Pub. No.: US 2007/0076899 A1
(43) Pub. Date: Apr. 5, 2007

(54) AUDIO COLLECTING DEVICE BY AUDIO INPUT MATRIX

(75) Inventor: Han Hsu, Hsin-tien City (TW)

Correspondence Address: ANTHONY R. BARKUME, 20 GATEWAY LANE, MANORVILLE, NY, 11949, US

(73) Assignee: OMNIDIRECTIONAL CONTROL TECHNOLOGY INC., Hsin-tien City (TW)

(21) Appl. No.: 11/459,702

(22) Filed: Jul. 25, 2006

(30) Foreign Application Priority Data
Oct. 3, 2005 (TW) 094134614

(51) Int. Cl. H04R 3/00; H04R 1/02

(52) U.S. Cl. 381/92; 381/91; 381/110

(57) ABSTRACT

An audio collecting device by audio input matrix comprises: a plurality of audio input devices for inputting audio sources and generating a plurality of audio signals; a plurality of sub-processors for connecting with a plurality of audio input devices to process the audio signals and generate audio processing signals of them, respectively; and a main processor electrically connecting with the plurality of sub-processors to process the audio processing signals as inputs for controlling these a plurality of sub-processors to do the synchronously sampling actions.

### FIELD OF THE INVENTION

The present invention relates to an audio collecting device by audio input matrix, especially for the audio collecting device that using a plurality of audio input devices as the audio input matrix.

### BACKGROUND OF THE INVENTION

Voice analysis will be one of the input solutions to replace the keyboard in the future. The related researches are more and more popular. The main purpose of voice analysis is making the electrical devices, computers, and other digital devices being able to understand and analyze human's voices for executing relative works. Audio is an analog signal, which is related with lots of complex variables such as timbre, volume, source, distance, and background noise, etc. Transferring an analog audio signal into a digital signal without any distortion, storing it and analyzing it is a very important topic. If we can analyze an audio signal, recognize it for correct timbre, volume, source, distance, and background noise, and transferring into correct words, it will be very useful in our daily lives.

The first lesson of voice analysis is getting the correct source very exactly. Microphone is the most popular audio input device, but a single microphone can improve the echo, filter background noises, and enhance the timbre only. A single microphone cannot collect the complete data of audio source and distance. Therefore, the concept of microphone matrix that uses several microphones to collect more and complete audio data would be able to understand the actual location and distance of audio source, and also be able to cancel the noise frequency, enhance the audio quality, and get a clean audio input.

The voice speed is 340.29 m/s. That is, the voice will be transferred in the air by 340.29 meters per second. It is very easy to measure the direction of audio source by the difference of the receiving time of the two audio receiving points. For example, if the distance between two microphones is 10 cm (0.1 m) and the voice maker is parallel with these two microphones, then the audio signal receiving time difference between the first microphone and the second microphone will be 0.2938 ms. Of course, if the voice maker is vertical with these two microphones (as an isosceles triangle which base is 10 cm), then the audio signal receiving time difference between these two microphones is zero. Further more, the other audio variables could be collected by more detailed and complex mathematics absolutely but which is not the main purpose of the present invention. To sum up, a microphone matrix can do more works than a single microphone for voice analysis.

FIG. 1 shows the block diagram of a traditional microphone matrix, which uses a CPU to do sampling, analyzing, and recognizing for respective voice. Audio sources from a plurality of microphones 11 will be converted from analog to digital (AD) as input signals, which need to do latency compensation process 12 because of the audio receiving time difference between every microphone. And then the Delay-and-Sum Beamforming 12 can cancel all the background noises. For spectrum analysis, using fast Fourier transfer 14 (FFT) will be able to get the audio spectrum. During the noise and echo canceling process 15, noise and echo can be filtered out by signal comparison. After audio processing and enlarging by amplify 16, and audio output 17, a complete audio signal can be provided as the audio source for voice analysis.

Audio signal can be gotten by sampling and processed by digital signal processing (DSP). For example, if the sampling rate is 8 KHz, that means the voice data will be sampling as 8,000 signals in one second sequentially before processing. That is, if this microphone matrix comprises ten microphones, the sampling rate will be 80,000 per second. In other words, every two microphones in this microphone matrix will have 1/80000-second audio signal receiving time error during the voice data sampling process. This tiny time difference will impact the voice analysis process in the next stage, absolutely. Although we may increase the sampling rate or use more complex algorithm to improve the time difference, but the hardware and software cost will also be increased.

Therefore, using a most simplest hardware system with the lowest cost to catch the voice data exactly, and the most efficient synchronous and separated calculation method is the main purpose of the present invention.

### BRIEF DESCRIPTION OF THE INVENTION

The main purpose of the present invention is designing a new, efficient, and useful audio collecting device by audio input matrix, which can get the audio signal exactly from every microphone to reduce the hardware and software cost, and can provide a better audio source to the voice analysis system at the next stage to enhance the analysis performance.

According to the present invention, an audio collecting device by audio input matrix comprises:

A plurality of audio input devices for inputting audio sources and generating a plurality of audio signals;

A plurality of sub-processors for connecting with a plurality of audio input devices to process the audio signals and generate audio processing signals of them, respectively; and

A main processor electrically connecting with the plurality of sub-processors to process the audio processing signals as inputs for controlling these a plurality of sub-processors to do the synchronously sampling actions.

In accordance with one aspect of the present invention, the plurality of audio input devices is a plurality of microphones.

In accordance with one aspect of the present invention, the plurality of audio input devices can be located linearly with the same distance, located irregularly for better audio collecting performance, or located with pair by pair for improving the performance.

In accordance with one aspect of the present invention, the main processor is able to generate feedback signals and clear voice signals to the plurality of sub-processors as the reference of the processing signals.

In accordance with one aspect of the present invention, the main processor is able to generate synchronous processing signals to the plurality of sub-processors for the synchronous sampling.

The present invention may best be understood through the following description with reference to the accompanying drawings, in which:

### BRIEF DESCRIPTION OF THE DRAWINGS

FIG. 1 shows the block diagram of the traditional microphones array.

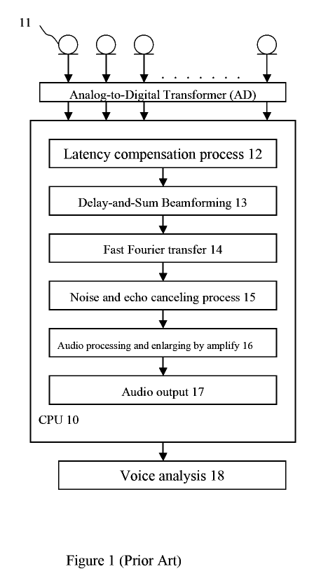

FIG. 2 shows the block diagram of the microphones array according to the present invention.

### DETAILED DESCRIPTION OF THE PREFERRED EMBODIMENT

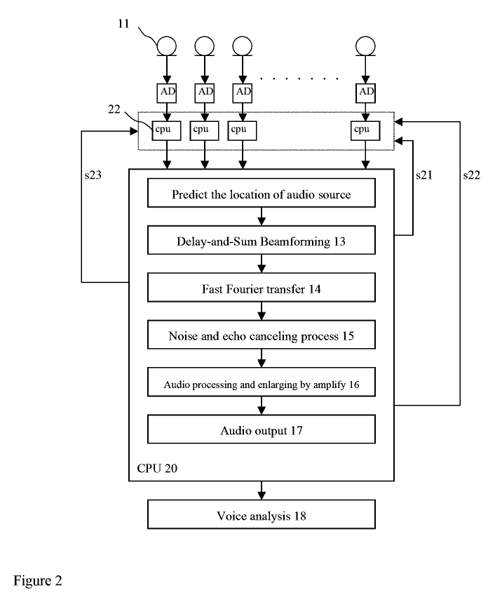

FIG. 2 shows the block diagram of the audio collecting devices by audio input matrix according to the present invention, which comprises multiple microphones 11, multiple sub-CPU 22, and one CPU 20. The analog audio signals of microphones 11 will be converted to digital signals by analog-to-digital converter AD, and will be input into the sub-CPU 22 for pre-processing and the sampling of the audio data. Because every microphone 11 is coupling with a single sub-CPU 22 for sampling, the time base of the sampling will be the same without any distortion. For example, a slow and cheap CPU will be able to support different sampling rates of 8 KHz, 16 KHz, or 32 KHz. Of course, the architecture of the present invention will be able to provide the best audio input performance by the lowest sampling rate.

After synchronizing the audio input without any distortion, we may analyze the variation of audio volume energy, entering speed of sound waves, and the variation of neighbored audio inputs, to judge the location of audio source and to use these data as the input of high speed CPU for post-process. For example, using delay—and sum beamforming 13, fast Fourier Transfer 14 (FFT), noise and echo-canceling process 15, audio processing and enhancing 16, and audio output 17 will provide the best performance of voice analysis 18. Of course, CPU 20 will get more extra bandwidth to process more calculations, and will use above results to generate feedback signal S21 and clean voice signal 22, entering back into the multiple sub-CPU 22 for getting more exact audio based variables and weighting processing them. On the other hand, CPU 20 is able to output synchronous process signal S23 to ask every sub-CPU 22 for executing synchronous sampling action to guarantee the time base of every sampling point is unique.

The audio collecting device by audio input matrix of the present invention is able to provide an exact audio input that provides the next stage audio processes a better performance and their output results also can be used on the other voice analysis based applications, such as digital-to-analog signal converting, sound enhancement processor, microphone output, digital audio storage, transferring voice data from USB to computers or providing voice data to vehicle guidance, etc.

To sum up, the present invention provides an audio collecting device by audio input matrix that improves the disadvantages of the traditional technology, and the advantages are listed as below:

1. Because the audio signal of every microphone is sampling by every respective sub-CPU, there is no any time-based distortion between these audio sources.

2. The hardware architecture is very simple without high level hardware and complex calculation that reduces the design of complexity.

3. Using multiple low-cost sub-CPUs for pre-processing is able to enhance the calculation performance and reduce the total cost of hardware architecture.

4. Getting a better audio input quality is able to judge the more exact audio source location, direction, and detailed processing and controlling.

5. Every single CPU sampling is able to enhance the reliability of the whole system. If there were any error occurred in any sampling point, it is easy to find it out by the whole average and filtering out the maximum or minimum to guarantee the performance of pre-processing and the stability of this system.

The technology of the present invention can be implemented by the skilled on the arts. The external and architecture design changes that are based on the present invention are all covered under the protecting area of the present invention, just likes to integrate the whole architecture into an FPGA or ASIC.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims that are to be accorded with the broadest interpretation so as to encompass all such modifications and similar structures.

What claims is:

1. An audio collecting device by audio input matrix comprising:
a plurality of audio input devices for inputting audio sources and generating a plurality of audio signals;
a plurality of sub-processors for connecting with a plurality of audio input devices to process said audio signals and generate audio processing signals of them, respectively; and
a main processor electrically connecting with said plurality of sub-processors to process said audio processing signals as inputs for controlling said a plurality of sub-processors to do the synchronously sampling actions.

2. The device according to claim 1 wherein said plurality of audio input devices is a plurality of microphones.

3. The device according to claim 1 wherein said plurality of audio input devices can be located linearly with the same distance, located irregularly for better audio collecting performance, or located with pair by pair for improving the performance.

4. The device according to claim 3 wherein said plurality of audio input devices is a plurality of microphones.

5. The device according to claim 1 wherein said main processor is able to generate feedback signals and clear voice signals to the plurality of sub-processors as the reference of the processing signals.

6. The device according to claim 1 wherein said main processor is able to generate synchronous processing signals to the plurality of sub-processors for the synchronous sampling.
